(19) United States
(12) Patent Application Publication
(10) Pub. No.: US 2016/0252919 A1
(43) Pub. Date: Sep. 1, 2016

(54) POWER SUPPLY CIRCUIT

(71) Applicant: KABUSHIKI KAISHA TOSHIBA, Tokyo (JP)

(72) Inventor: Akihiro TANAKA, Yokohama Kanagawa (JP)

(21) Appl. No.: 14/839,627

(22) Filed: Aug. 28, 2015

(30) Foreign Application Priority Data
Feb. 27, 2015 (JP) 2015-039015

(51) Int. Cl. G05F 1/575; G05F 1/56

(52) U.S. Cl. CPC G05F 1/575; G05F 1/56

(57) ABSTRACT

A power supply circuit includes a low drop out regulator generating an output voltage according to an input voltage and a booster circuit that increases responsiveness of the regulator with respect to variations in the output voltage. The regulator includes an amplifier and a first transistor that outputs the output voltage with a voltage level according to output from the amplifier. The booster circuit includes a second transistor outputting current which is proportional to output current of the first transistor and a first differential amplifier outputting a voltage signal according to a difference between a voltage corresponding to an output current of the second transistor and a reference voltage. A control circuit controls responsiveness of the amplifier according to the voltage signal.

### CROSS-REFERENCE TO RELATED APPLICATION

This application is based upon and claims the benefit of priority from Japanese Patent Application No. 2015-039015, filed Feb. 27, 2015, the entire contents of which are incorporated herein by reference.

### FIELD

Embodiments described herein relate generally to a power supply circuit including an LDO regulator.

### BACKGROUND

In a small-sized electronic device, such as a smart phone or a cellular phone, component housing space is limited due to heat dissipation and sizing requirements. There is insufficient space for mounting a fan in such a device, and thus heat buildup becomes problematic in many cases. For this reason, a low drop out (LDO) regulator is used for a power supply circuit in this type of electronic device. An LDO regulator suppresses a voltage drop of an output voltage with respect to an input voltage.

In an LDO regulator, in order to better suppress a decrease of an output voltage with respect to load variation, it is preferable that the size of an output transistor in the LDO regulator is large. However, in general, the larger the size of the output transistor is, the poorer its responsiveness. Thus, a booster circuit that is provided in a front stage of the LDO regulator has been proposed to improve responsiveness.

However, in the related art, since the booster circuit operates only when a load variation occurs, time loss until the booster circuit operates is still present, and thus responsiveness still is not always good.

### DESCRIPTION OF THE DRAWINGS

FIG. 1 is a circuit diagram of a power supply circuit according to a first embodiment.

FIG. 2 is a circuit diagram illustrating an example of an internal configuration of a first stage amplifier.

FIG. 3 is a circuit diagram of a power supply circuit according to a comparison example.

FIG. 4 is a circuit diagram of a power supply circuit in which a first transistor and a second transistor include NMOS transistors.

FIG. 5 is a circuit diagram of a power supply circuit according to a second embodiment.

FIG. 6 is a circuit diagram of a power supply circuit according to a modification example in FIG. 5.

FIG. 7 is a circuit diagram of a power supply circuit according to a third embodiment.

FIG. 8 is a circuit diagram of a power supply circuit according to the second embodiment to which a voltage hysteresis circuit is added.

FIG. 9 is a circuit diagram of a power supply circuit according to a fourth embodiment.

### DETAILED DESCRIPTION

In an example embodiment, a power supply circuit with high-speed responsiveness with respect to load variation is described.

In general, according to one embodiment, a power supply circuit includes: a low drop out (LDO) regulator configured to generate an output voltage according to an input voltage; and a booster circuit configured to improve responsiveness of the LDO regulator with respect to variation of the output voltage. The LDO regulator includes an amplifier configured to outputs a voltage according to the variation in the output voltage and a first transistor that outputs the output voltage at a voltage level according to the first voltage which is output from the amplifier. The booster circuit includes a second transistor configured to output an output current that is proportional to an output current of the first transistor; a first differential amplifier configured to output a first voltage signal according to a voltage difference between a voltage corresponding to the output current of the second transistor and a first reference voltage; and a control circuit configured to control responsiveness of the amplifier according to the first voltage signal that changes according to the voltage difference.

Hereinafter, embodiments will be described with reference to the drawings. The following embodiments will be described with a focus on the characteristic configuration and operation of a power supply circuit, but configurations and operations which are omitted in the following description may exist in the power supply circuit. However, the configurations and operations which are omitted are also included in the scope of the present embodiments.

### First Embodiment

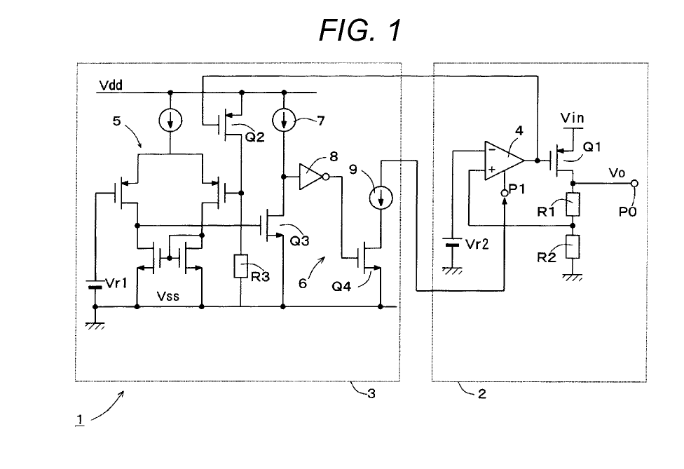

FIG. 1 is a circuit diagram of a power supply circuit 1 according to a first embodiment. The power supply circuit 1 in FIG. 1 includes a LDO regulator 2 that outputs an output voltage Vo according to an input voltage Vin, and a booster circuit 3 that increases responsiveness of the LDO regulator 2 with respect to the variation of the output voltage Vo.

The output voltage Vo of the LDO regulator 2 is the output voltage Vo of the power supply circuit 1 in FIG. 1, and hereinafter, a port (terminal) from which the output voltage Vo is output may be referred to as an output port P0. In general, a load such as an electronic device is connected to the output port P0. There is a case in which a load suddenly changes the load current of the LDO regulator 2 to, for example, several hundred milliamperes (mA) over a very short time such as microseconds. Since a LDO regulator 2 that operates with a consumption current equal to or lower than several microamperes does not follow the variation in the load current of several hundred milliamperes (mA), there is a possibility that the output voltage Vo is significantly decreased. The booster circuit 3 is provided in order to suppress a temporary decrease in the output voltage Vo.

The LDO regulator 2 in FIG. 1 includes a first stage amplifier 4 that outputs a voltage which varies according to the variation of the output voltage Vo, and a first transistor Q1 that outputs the output voltage Vo with a voltage level according to the voltage which is output from the first stage amplifier 4.

The booster circuit 3 includes a second transistor Q2 that outputs an output current which is proportional to the output current of the first transistor Q1, a first differential amplifier 5 that outputs a voltage signal according to a voltage difference between a voltage according to the output current of the second transistor Q2 and a first reference voltage Vr1, and a control circuit 6 that controls the responsiveness of the first stage amplifier 4 in accordance with the voltage signal which is output from the first differential amplifier 5.

Both the first transistor Q1 and the second transistor Q2 which are illustrated in FIG. 1 are PMOS transistors, but may be NMOS transistors as will be described later. In addition, the first transistor Q1 and the second transistor Q2 may also include bipolar transistors. In the present disclosure, the source-drain currents of the first transistor Q1 and the second transistor Q2 are referred to as output currents of the first transistor Q1 and the second transistor Q2.

To begin with, a circuit configuration and an operation in the LDO regulator 2 will be described. An input voltage Vin is supplied to the source of the first transistor Q1 in the LDO regulator 2, and the output voltage Vo is output from the drain of the first transistor Q1. Two impedance circuits (first impedance circuit) R1 and R2 are connected in series to each other between the drain of the first transistor Q1, that is, the output port P0 and a ground voltage node Vss. A voltage that is output from the first stage amplifier 4 is input to the gate of the first transistor Q1.

The input voltage Vin is generated by an individual power supply circuit that is not specifically illustrated. The LDO regulator 2 generates the output voltage Vo with a voltage level close to the input voltage Vin, and has characteristics in which, even when load variation occurs, the variation of the output voltage Vo is small.

The first stage amplifier 4 in the LDO regulator 2 compares a voltage that is obtained by dividing the output voltage Vo using the two impedance circuits R1 and R2 with a second reference voltage Vr2, and supplies a voltage signal according to the voltage difference to the gate of the first transistor Q1.

The drain of the first transistor Q1 is connected to the output port P0 that outputs the output voltage Vo. When a load that is connected to the output port P0 becomes heavy, the drain current of the first transistor Q1 increases, and the output voltage Vo (that is, the drain voltage of the first transistor Q1) decreases. Since the first stage amplifier 4 performs a feedback operation that suppresses a decrease of the output voltage Vo, a voltage that is output from the first stage amplifier 4 decreases, the first transistor Q1 operates so as to be turned on (increase source to drain conductance), and an operation of increasing the drain current of the first transistor Q1 and increasing the output voltage Vo is thus performed.

In contrast to this, when a load becomes light, the drain current of the first transistor Q1 decreases, and the output voltage Vo increases. Thus, the voltage that is output from the first stage amplifier 4 increases, the first transistor Q1 operates so as to be turned off (decrease source to drain conductance), and an operation of decreasing the drain current of the first transistor Q1 and decreasing the output voltage Vo is performed. Owing to this, the LDO regulator 2 performs an operation that suppresses variation of the output voltage Vo caused by load variations.

Next, a circuit configuration and an operation of the booster circuit 3 will be described. The booster circuit 3 includes the first differential amplifier 5 that is connected between a power supply voltage node Vdd and the ground voltage node Vss, the second transistor Q2 and an impedance circuit (second impedance circuit) R3 that are connected in series to each other between the power supply voltage node Vdd and the ground voltage node Vss, and the control circuit 6 that is connected between the power supply voltage node Vdd and the ground voltage node Vss. The impedance circuit R3 may include one or more resistor elements.

The second transistor Q2 outputs a current that is proportional to a current which flows between the source and drain of the first transistor Q1. The gate of the second transistor Q2 is connected to the gate of the first transistor Q1, and the first transistor Q1 and the second transistor Q2 together form a current mirror circuit. A value that is obtained by dividing a gate width of the first transistor Q1 by a gate length of the first transistor Q1 is greater than a value that is obtained by dividing a gate width of the second transistor Q2 by a gate length of the second transistor Q2. As a result, the source-drain current of the second transistor Q2 is smaller than the source-drain current of the first transistor Q1. In this way, by making the source-drain current of the second transistor Q2 to be smaller than the source-drain current of the first transistor Q1, power consumption of the booster circuit 3 may be reduced.

The first differential amplifier 5 outputs a voltage signal according to a difference between the voltage according to the output current of the second transistor Q2 and the first reference voltage Vr1.

The control circuit 6 controls the responsiveness of the first stage amplifier 4 in accordance with the voltage signal output from the first differential amplifier 5. More specifically, the control circuit 6 includes a first current source 7 and a third transistor Q3 that are connected in series between the power supply voltage node Vdd and the ground voltage node Vss, an inverter 8 that inverts a voltage of a connection node between the first current source 7 and the third transistor Q3, and a second current source 9 and a fourth transistor Q4 that are connected in series between a control port P1 of the first stage amplifier 4 and the ground voltage node Vss.

In the example in FIG. 1, both of the third transistor Q3 and the fourth transistor Q4 include NMOS transistors, but may also include PMOS transistors. The voltage signal that is output from the first differential amplifier 5 is input to the gate of the third transistor Q3. The drain of the third transistor Q3 is connected to the first current source 7 and the input terminal of the inverter 8, and the source of the third transistor Q3 is grounded. The output voltage of the inverter 8 is input to the gate of the fourth transistor Q4. The drain of the fourth transistor Q4 is connected to the second current source 9, and the source of the fourth transistor Q4 is grounded.

The voltage level of the power supply voltage node Vdd in the booster circuit 3 may be equal to the voltage level of the input voltage Vin in the LDO regulator 2, or may be different from the voltage level of the input voltage Vin.

As long as a load current flows through the output port P0 of the LDO regulator 2, the control circuit 6 is configured to turn on the fourth transistor Q4, regardless of the magnitude of the load current, and performs a control of improving the responsiveness of the first stage amplifier 4 in the LDO regulator 2.

Next, an operation of the power supply circuit 1 in FIG. 1 will be described. When a load rapidly becomes heavy and thereby a load current flowing into the load via the output port P0 from the first transistor Q1 is increased, the source-drain current of the second transistor Q2 that configures a current mirror circuit together with the first transistor Q1 is also increased. As a result, the drain voltage of the second transistor Q2 is increased. Thus, the output voltage of the first differential amplifier 5 is increased, and the third transistor Q3 operates so as to be turned on. As a result, the input voltage of the inverter 8 is decreased, and the output voltage of the inverter 8 is increased. Thus, the fourth transistor Q4 operates so as to be turned on, and an operation in which more current flows out from the control port P1 of the first stage amplifier 4 and into the ground voltage node Vss via the drain and source of the fourth transistor Q4 is performed.

The fact that more current flows out from the control port P1 of the first stage amplifier 4 means that frequency characteristics, that is, responsiveness of the first stage amplifier 4 is increased.

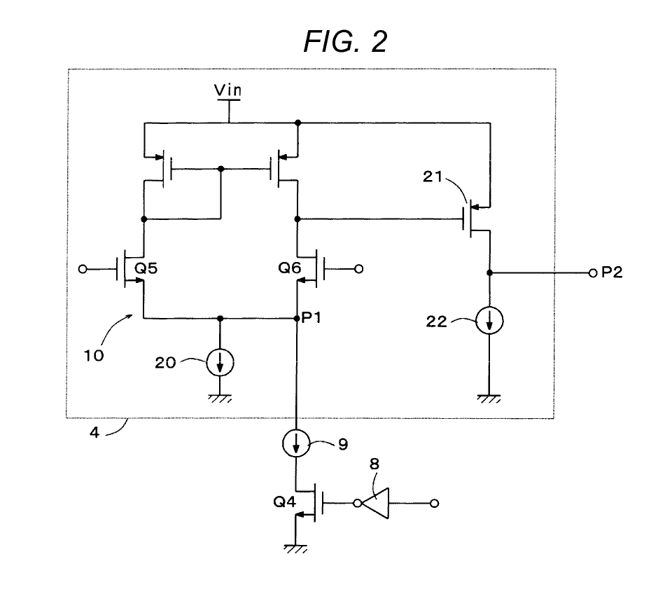

FIG. 2 is a circuit diagram illustrating an example of an internal configuration of the first stage amplifier 4. The first stage amplifier 4 in FIG. 2 includes a second differential amplifier 10, a current source 20, a PMOS transistor 21 that amplifies the output of the second differential amplifier 10, and a current source 22 that is connected to the drain of the transistor 21. A connection node P2 between the drain of the transistor 21 and the current source 22 is the output node of the first stage amplifier 4, and is connected to the gate of the first transistor Q1 in FIG. 1. The second differential amplifier 10 includes a fifth transistor Q5 having a gate to which the second reference voltage Vr2 is input, and a sixth transistor Q6 having a gate to which a division voltage that is obtained by dividing the output voltage Vo is input. Both of the sources of the fifth transistor Q5 and the sixth transistor Q6 are connected to the current source 20. Thus, the drain-source currents of the fifth transistor Q5 and the sixth transistor Q6 depend on the current supplied by the current source 20, and the more the current source 20 outputs current, the more the drain-source currents of the fifth transistor Q5 and the sixth transistor Q6 increase. Thereby operation speed of the fifth transistor Q5 and the sixth transistor Q6 becomes faster. The control port P1 is connected to one terminal of the current source 20, and when more current flows out from the control port P1, the same effect that a supply current of the current source 20 is increased is obtained, the operation speed of the fifth transistor Q5 and the sixth transistor Q6 becomes faster, and the frequency characteristics, that is, responsiveness of the first stage amplifier 4 is increased. Thus, a decrease of the output voltage Vo due to an increase of a load current can be more rapidly suppressed.

In the power supply circuit 1 in FIG. 1, when a load rapidly becomes light and a load current flowing through the load via the output port P0 from the first transistor Q1 is decreased, the source-drain current of the second transistor Q2 (that configures a current mirror circuit together with the first transistor Q1) is decreased. However, as long as a load current flows, the source-drain current of the second transistor Q2 also continues to flow, and thus, the output voltage of the first differential amplifier 5 maintains a voltage level that continues to turn on the third transistor Q3. Thus, the fourth transistor Q4 also maintains an ON state, a flowing out of a current from the control port P1 of the first stage amplifier 4 is continued, and an operation of increasing the responsiveness of the first stage amplifier 4 is continuously performed. In this way, as long as the load current flows, the booster circuit 3 performs an operation of increasing the responsiveness of the first stage amplifier 4.

Meanwhile, if the load current becomes completely zero, the drain voltage of the second transistor Q2 is decreased. Thus, the output voltage of the first differential amplifier 5 is decreased, and the third transistor Q3 operates so as to be turned off. As a result, the input voltage of the inverter 8 is increased, and the output voltage of the inverter 8 is decreased. Thus, the fourth transistor Q4 operates so as to be turned off, and a flowing out of a current from the control port P1 of the first stage amplifier 4, that is, the responsiveness of the first stage amplifier 4 is not increased.

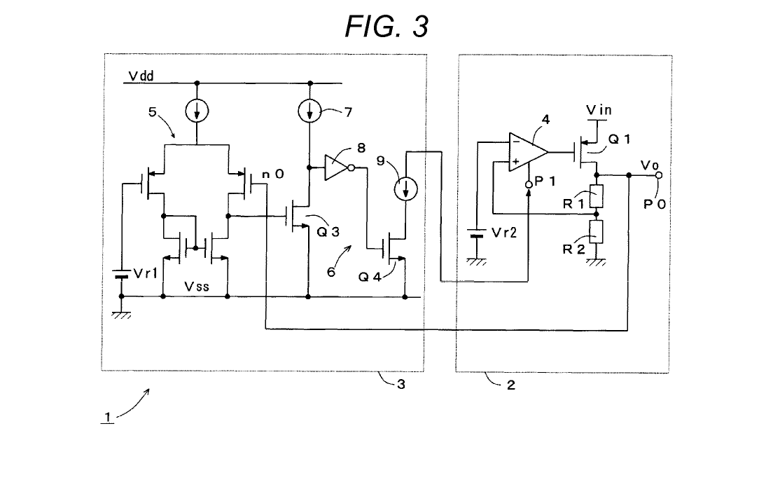

FIG. 3 is a circuit diagram of the power supply circuit 1 according to a comparison example. In FIG. 3, the same symbols or reference numerals as in FIG. 1 are attached to the configuration components corresponding to those in FIG. 1. In the power supply circuit 1 in FIG. 3, the output port P0 of the LDO regulator 2 is connected to an input node n0 of the first differential amplifier 5 in the booster circuit 3. In the power supply circuit 1 in FIG. 3, the second transistor Q2 and the impedance circuit R3 are not included.

In the power supply circuit 1 in FIG. 3, when a load current is rapidly increased, the output voltage Vo is decreased, and as a result, the output voltage of the first differential amplifier 5 is decreased. Hereinafter, the same operation as in FIG. 1 is performed, whereby the responsiveness of the first stage amplifier 4 is increased.

In this way, the power supply circuit 1 in FIG. 3 directly inputs the output voltage Vo of the LDO regulator 2 to the input node n0 of the first differential amplifier 5 in the booster circuit 3, thereby detecting variation of the output voltage Vo. A voltage level of the output voltage Vo of the LDO regulator 2 instantaneously varies according to load variation. In the same manner as the power supply circuit 1 in FIG. 3, even when the output voltage Vo is directly fed back to the booster circuit 3 thereby controlling the LDO regulator 2, the booster circuit 3 cannot completely follow the variation of the output voltage Vo, and as a result, the variation of the output voltage Vo cannot be rapidly suppressed.

In addition, in the same manner as the power supply circuit 1 according to the comparison example (illustrated in FIG. 3), in a method of feeding back the output voltage Vo of the LDO regulator 2 into the booster circuit 3, when being fabricated as a semiconductor chip, a difference in responsiveness of the LDO regulator 2 with respect to the load variation occurs also by an arrangement of the first transistor Q1 and the booster circuit 3 on the device layout pattern. That is, effectiveness of the booster circuit 3 may vary from each other due to the layout pattern or other variations in fabrication.

In contrast to this, in the power supply circuit 1 in FIG. 1, a period in which the load current flows is continued, and an operation of increasing the responsiveness of the first stage amplifier 4 using the second transistor Q2 that configures a current mirror circuit is performed, and it is possible to suppress the decrease of the output voltage Vo more rapidly than the power supply circuit 1 in FIG. 3.

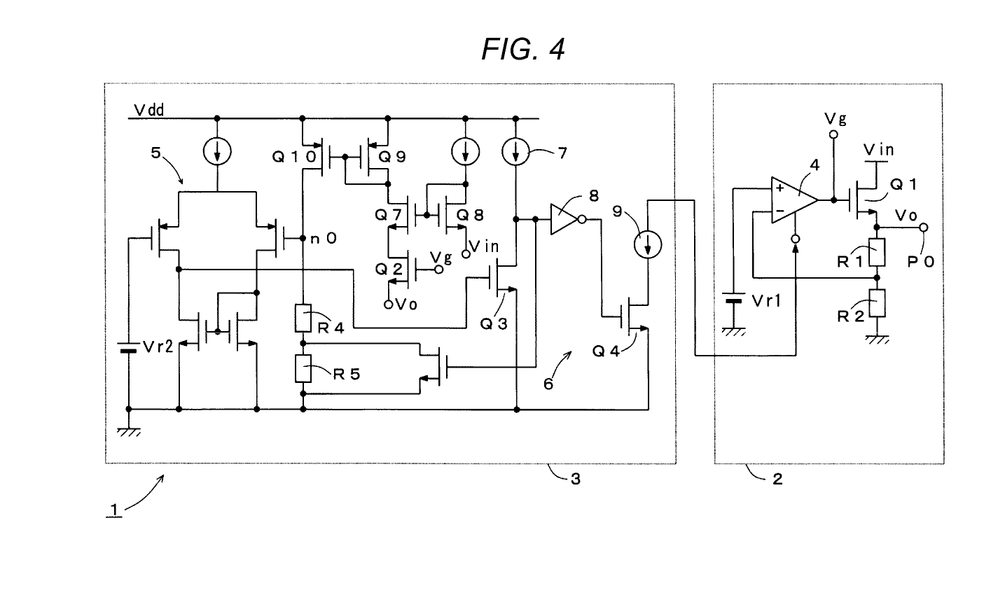

FIG. 1 illustrates an example in which the first transistor Q1 and the second transistor Q2 form a current mirror circuit in the power supply circuit 1 and includes PMOS transistors, but these transistors may also include NMOS transistors. FIG. 4 is a circuit diagram of the power supply circuit 1 in which the first transistor Q1 and the second transistor Q2 include NMOS transistors.

The drain of the second transistor Q2 in the booster circuit 3 that configures a current mirror circuit together with the first transistor Q1 in the LDO regulator 2 in FIG. 4 is connected to the source of a seventh transistor Q7, and a voltage of the source of the second transistor Q2 is set to be equal the output voltage Vo of the LDO regulator 2. The seventh transistor Q7 forms a current mirror circuit together with an eighth transistor Q8, and the input voltage Vin is supplied to the source of the eighth transistor Q8. The drain of a ninth transistor Q9 is connected to the drain of the seventh transistor Q7. The ninth transistor Q9 configures a current mirror circuit together with a tenth transistor Q10, the source of the tenth transistor Q10 is connected to the power supply voltage node Vdd, and two impedance circuits R4 and R5 are connected in series between the drain of the tenth transistor Q10 and the ground voltage node Vss. The drain of the tenth transistor Q10 is connected to the input node n0 of the first differential amplifier 5.

The control circuit 6 in the booster circuit 3 in FIG. 4 is the same as that in FIG. 1, and thus, description thereof will be omitted. In the power supply circuit 1 in FIG. 4, when a load current increases, the drain-source current of the first transistor Q1 increases, and according to this, the drain-source current of the second transistor Q2, that forms a current mirror circuit together with the first transistor Q1, also increases. As a result, the source-drain current of the tenth transistor Q10 also increases, the voltage of the input node n0 of the first differential amplifier 5 increases, the output voltage of the first differential amplifier 5 increases, the third transistor Q3 operates so as to be turned on, more current from the control port P1 of the first stage amplifier 4 in the LDO regulator 2 flows out, whereby the responsiveness of the first stage amplifier 4 is increased.

In this way, in the power supply circuit 1 according to the first embodiment, the second transistor Q2, which configures a current mirror circuit together with the first transistor Q1 connected to an output port P0 of the LDO regulator 2, is provided inside of the booster circuit 3, and as long as a load current flows, an operation of increasing the responsiveness of the first stage amplifier 4 in the LDO regulator 2 is continuously performed, and thus, it is possible to rapidly control a decrease of the output voltage Vo according to an increase of the load current, without substantially complicating a circuit configuration and in addition, without increasing current consumption. As a result, a problem is also solved in which the booster circuit 3 cannot follow the variation of the output voltage Vo.

When a current mirror circuit as described above is not included, the effectiveness of the booster circuit 3 at the time of load variation can be changed by a positional relationship between the first transistor Q1 and the booster circuit 3 in a device layout pattern, but in the present embodiment, the responsiveness of the booster circuit 3 is increased by the current mirror circuit, and thus regardless of the layout pattern influence, it is possible to stably suppress the variation of the output voltage Vo with respect to a load variation.

### Second Embodiment

A second embodiment is different from the first embodiment in a way a load current is detected.

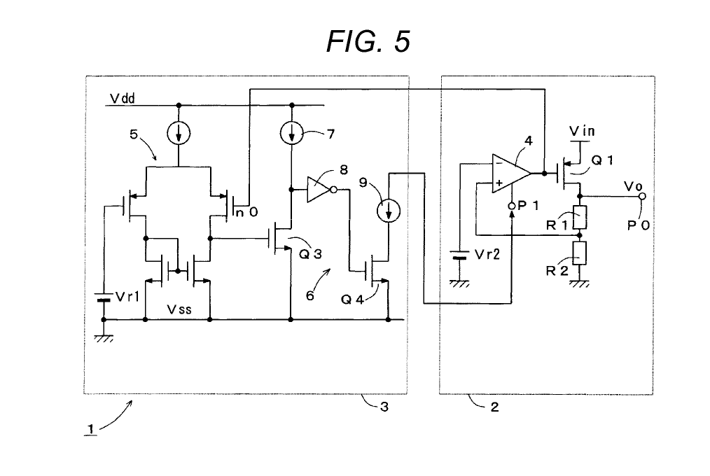

FIG. 5 is a circuit diagram of the power supply circuit 1 according to the second embodiment. The same symbols or reference numerals as in FIG. 5 are attached to the same configuration components as in FIG. 1, and hereinafter, description thereof will be made with a focus on points different from each other.

The power supply circuit 1 in FIG. 5 supplies the output voltage of the first stage amplifier 4 in the LDO regulator 2 to one input node n0 of the first differential amplifier 5 in the booster circuit 3. The output node (node connected to gate of third transistor Q3) of the first differential amplifier 5 is provided on a side opposite to that depicted in FIG. 1. In addition, the second transistor Q2 and the impedance circuit R3, which are included in the power supply circuit 1 in FIG. 1, but are not included in the power supply circuit 1 in FIG. 5. Except for this, the power supply circuit 1 in FIG. 5 is similar to the power supply circuit 1 in FIG. 1.

Hereinafter, an operation of the power supply circuit 1 in FIG. 5 will be described. When a load current flowing from the first transistor Q1 in the LDO regulator 2 via the output port P0 rapidly increases, the gate voltage of the first transistor Q1 decreases. As a result, the voltage of one input node n0 of the first differential amplifier 5 in the booster circuit 3 decreases, and the output voltage of the first differential amplifier 5 increases. Thus, the third transistor Q3 operates so as to be turned on, and the output voltage of the inverter 8 increases. As a result, the fourth transistor Q4 also operates so as to be turned on, thus more current flows out from the control port P1 of the first stage amplifier 4 in the LDO regulator 2, the responsiveness of the first stage amplifier 4 is thereby increased, and a decrease of the output voltage Vo according to an increase of a load current is rapidly suppressed.

In contrast to this, when a load current is rapidly decreased, the gate voltage of the first transistor Q1 increases. However, as long as the load current flows, an increase of the gate voltage of the first transistor Q1 is suppressed to a voltage lower than a gate voltage at the time of completely turning off the first transistor Q1. Thus, the third transistor Q3 in the booster circuit 3 is maintained in an ON state, and the fourth transistor Q4 is also maintained in an ON state. Thus, as in the first embodiment, as long as the load current flows, the booster circuit 3 continuously increases the responsiveness of the first stage amplifier 4 in the LDO regulator 2. Meanwhile, when the load current becomes zero, the gate voltage of the first transistor Q1 increases up to a voltage level that turns off the first transistor Q1, the output voltage of the first differential amplifier 5 in the booster circuit 3 decreases, the third transistor Q3 and the fourth transistor Q4 are both turned off, and an operation for increasing the responsiveness of the first stage amplifier 4 is not performed.

The power supply circuit 1 in FIG. 5 feeds back the gate voltage of the first transistor Q1 into one input node n0 of the first differential amplifier 5 in the booster circuit 3, thus when the gate voltage of the first transistor Q1 rapidly varies in accordance with the variation of the source-drain current of the first transistor Q1 corresponding to the load current, it is possible to feed back the variation of the load current into the booster circuit 3 with similar rapidity as in the power supply circuit 1 in FIG. 1, which feeds back the source-drain current of the first transistor Q1 into the booster circuit 3 using a current mirror circuit.

Variation of the output voltage Vo due to variation of the load current is instantaneous, and to suppress the variation of the output voltage Vo, the responsiveness of the booster circuit 3 to detected variations has to be good. Feeding back the gate voltage of the first transistor Q1 is perhaps easier to control, than feeding back by capturing the output voltage Vo. That is, more current usually flows out from the control port P1 of the first stage amplifier 4 while the load current flows, and thereby the responsiveness of the first stage amplifier 4 is increased, and it is possible to follow an instantaneous variation in the output voltage Vo. Thus, the power supply circuit 1 in FIG. 5 feeds back the gate voltage of the first transistor Q1 into the booster circuit 3.

Furthermore, the power supply circuit 1 in FIG. 5 feeds back the load current into the booster circuit 3 without using a current mirror circuit, which is different from the power supply circuit 1 in FIG. 1, and thus there is an advantage for the second embodiment in that current consumption in the current mirror circuit does not occur.

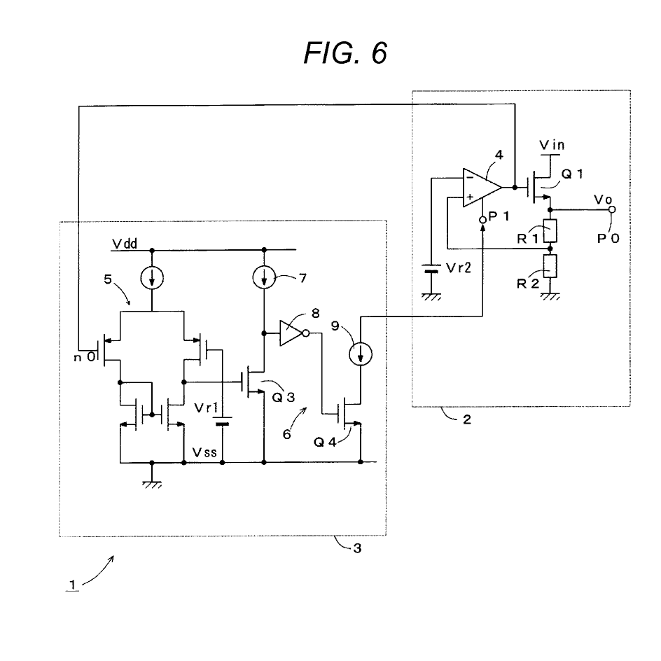

An example in which the first transistor Q1 is a PMOS transistor is illustrated in FIG. 5, but the first transistor Q1 may also be an NMOS transistor. FIG. 6 is a circuit diagram of the power supply circuit 1 according to a modification example in FIG. 5, and illustrates an example in which the first transistor Q1 is an NMOS transistor.

The power supply circuit 1 in FIG. 6 is the same as that in FIG. 5 in that the gate voltage of the first transistor Q1 is fed back into one input node n0 of the first differential amplifier 5 in the booster circuit 3, but is different from that in FIG. 5 in that an output node of the first differential amplifier 5 is on the drain side of a transistor having a gate to which the first reference voltage Vr1 is input.

In this way, in the second embodiment, the variation of the load current flowing from the first transistor Q1 in the LDO regulator 2 via the output port P0 is detected by the gate voltage of the first transistor Q1, the gate voltage is fed back into the first differential amplifier 5 in the booster circuit 3, and thus it is possible to rapidly suppress the variation of the output voltage Vo with respect to the variation of the load current, using a circuit configuration simpler than the power supply circuit 1 in FIG. 1.

### Third Embodiment

A third embodiment that will be described below may be used to prevent the power supply circuit 1 from oscillating.

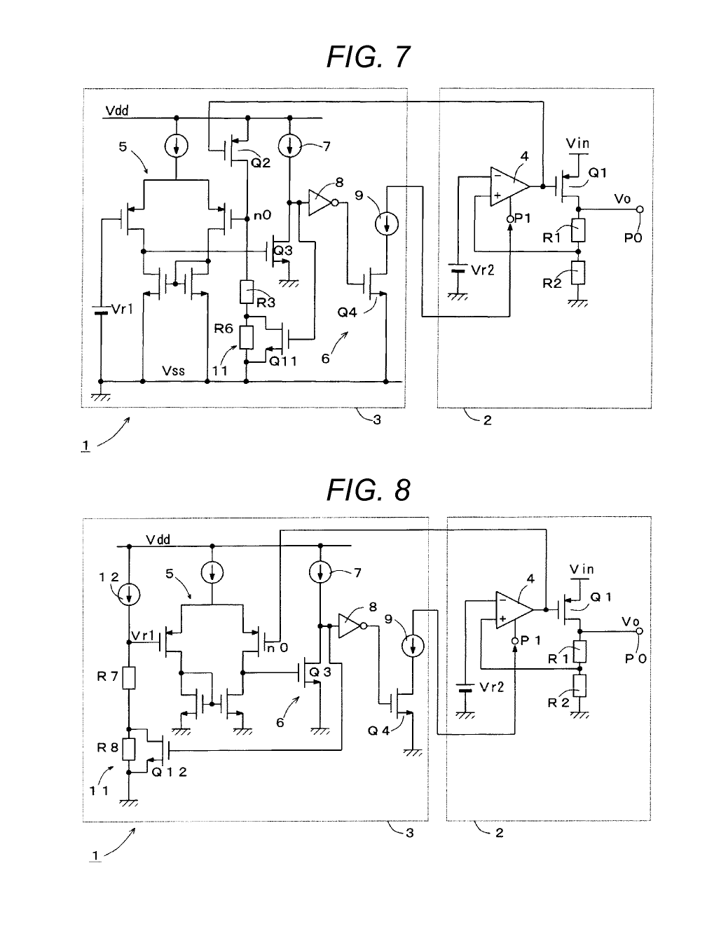

FIG. 7 is a circuit diagram of the power supply circuit 1 according to the third embodiment. The power supply circuit 1 in FIG. 7 corresponds to the power supply circuit 1 in FIG. 1 to which a voltage hysteresis circuit 11 for preventing oscillation has been added. The voltage hysteresis circuit 11 is provided in the booster circuit 3. More specifically, the second transistor Q2, the impedance circuit R3, and the voltage hysteresis circuit 11 are connected in series between the power supply voltage node Vdd and the ground voltage node Vss.

The voltage hysteresis circuit 11 is a circuit in which an impedance circuit R6 and an eleventh transistor Q11 are connected in parallel with each other. The eleventh transistor Q11 is, for example, an NMOS transistor, and the gate thereof is connected to the input node of the inverter 8.

The input node of the inverter 8 is in a high level in a normal state during which a load current does not flow. Thus, in a normal state, the eleventh transistor Q11 is turned on, and voltage drop does not occur in the voltage hysteresis circuit 11. When the load current flows, the input node of the inverter 8 is supplied with a low level, and the eleventh transistor Q11 is turned off. As a result, the second transistor Q2 and two impedance circuits R3 and R6 are connected in series between the power supply voltage node Vdd and the ground voltage node Vss, and a voltage of one input node n0 of the first differential amplifier 5 further increases. Thus, a voltage of the output node of the first differential amplifier 5 increases, the third transistor Q3 is rapidly turned on, and current flows out from the control port P1 of the first stage amplifier 4 at a faster timing. In this state, when the load current is decreased, the voltage of the one input node n0 of the first differential amplifier 5 is decreased, and the output voltage of the first differential amplifier 5 is increased. However, until the voltage of the input node of the inverter 8 exceeds the threshold voltage of the eleventh transistor Q11, that is, until the load current becomes completely zero, the voltage of the one input node n0 of the first differential amplifier 5 is maintained in an increased state by the voltage hysteresis circuit 11, it is possible to prevent the first differential amplifier 5 from entering an oscillation state in which a voltage level of the output voltage of the first differential amplifier 5 fluctuates in a short time period, and to increase stability against oscillation.

The voltage hysteresis circuit 11 may also be provided to the power supply circuits 1 depicted in FIG. 2, FIG. 5, and FIG. 6, in addition to FIG. 1. For example, FIG. 8 is a circuit diagram of the power supply circuit 1 in which the voltage hysteresis circuit 11 has been added to the power supply circuit depicted in FIG. 5. The voltage hysteresis circuit 11 in FIG. 8 controls the first reference voltage Vr1 in the booster circuit 3, and includes a current source 12 and a plurality of impedance circuits R7 and R8 which are connected in series between the power supply voltage node Vdd and the ground voltage node Vss, and a twelfth transistor Q12 that is connected in parallel with the impedance circuit R8. The gate of the twelfth transistor Q12 is connected to the input node of the inverter 8. The first reference voltage Vr1 is output from a connection node between the impedance circuit R7 connected to the current source 12 and the current source 12, and is supplied to the first differential amplifier 5.

In the power supply circuit 1 depicted in FIG. 8, the input node of the inverter 8 is supplied with a high level, and the twelfth transistor Q12 is turned on, in a normal state during which a load current does not flow. In this state, the drain and source of the twelfth transistor Q12 are disconnected from each other. When the load current flows, the input node of the inverter 8 becomes low, the twelfth transistor Q12 is turned off. As a result, the voltage level of the first reference voltage Vr1 that is supplied to the first differential amplifier 5 becomes high. Thereafter, even when the load current is decreased, the voltage level of the first reference voltage Vr1 that is supplied to the first differential amplifier 5 is maintained in a high level, until the input node of the inverter 8 becomes high, and thus there is no possibility that the output voltage of the first differential amplifier 5 oscillates.

In this way, according to the third embodiment, the voltage hysteresis circuit 11 is provided in the booster circuit 3, and the booster circuit 3 does not oscillates, and it is possible to increase device stability against oscillation.

### Fourth Embodiment

In a fourth embodiment, when a load rapidly becomes light, the power supply circuit 1 the output voltage Vo does not rapidly increase.

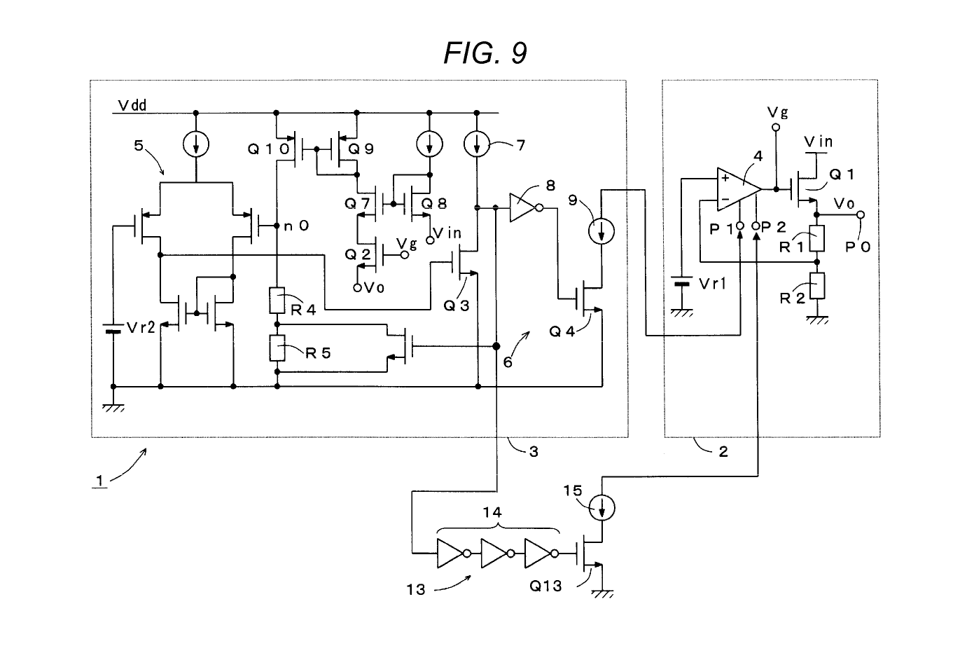

FIG. 9 is a circuit diagram of the power supply circuit 1 according to a fourth embodiment. The power supply circuit 1 in FIG. 9 is similar to the power supply circuit 1 in FIG. 4 to which a delay circuit 13 has been added. The delay circuit 13 includes an inverter group 14 having an odd number of stages which inverts a voltage of the input node of the inverter 8 in the booster circuit 3, a thirteenth transistor Q13 having a gate to which the final output node of the inverter group 14 is connected, and a current source 15 that is connected between the drain of the thirteenth transistor Q13 and the control port P2 of the first stage amplifier 4 in the LDO regulator 2. The number of stages in the inverter group 14 is not limited to three stages as illustrated in FIG. 9, but may be any odd number of stages.

While a load current flows, the delay circuit 13 takes out a current from the first stage amplifier 4, and performs an operation in which the current flows into the current source 15 and the thirteenth transistor Q13. As a result, it is possible to increase the responsiveness of the first stage amplifier 4.

More specifically, when the load current flows, the input node of the inverter 8 in the booster circuit 3 is supplied with a low level, the output of the inverter group 14 in the delay circuit 13 is supplied with a high level. Thus, the thirteenth transistor Q13 is turned on, more current flows out from the first stage amplifier 4, and flows into the ground voltage node Vss via the current source 15 and the thirteenth transistor Q13. As a result, the responsiveness of the first stage amplifier 4 is increased. The operation is continuously performed as long as the load current flows.

When the load current becomes zero, the input node of the inverter 8 in the booster circuit 3 is supplied with a high voltage, the booster circuit 3 does not perform a flowing out of a current from the first stage amplifier 4. However, since the inverter group 14 is included in the delay circuit 13, even when the load current becomes zero, the thirteenth transistor Q13 is maintained in an ON state for a while (for a time corresponding to the delay timing), and continuously performs a flowing out of a current from the first stage amplifier 4. As a result, even when the load current becomes zero, any abnormality in which the output voltage Vo is rapidly increased does not occur.

The delay circuit 13 in FIG. 9 may be added to the power supply circuits 1 depicted in FIG. 2, FIG. 5, and FIG. 6 in addition to FIG. 1. In addition, the voltage hysteresis circuit 11 and the delay circuit 13 which are described in the third embodiment may both be added to the power supply circuit 1 such as that depicted in FIG. 1 (or the other FIGs).

In this way, in the fourth embodiment, the delay circuit 13 is provided and thereby when the load current flows, an operation of further increasing the responsiveness of the first stage amplifier 4 in the LDO regulator 2 is performed. Even when the load current becomes zero, an operation of increasing the responsiveness of the first stage amplifier 4 is continuously performed for a while after the load current becomes zero, and thus, it is possible to prevent the output voltage Vo from rapidly increasing immediately after the load current becomes zero.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A power supply circuit, comprising:
a low drop out (LDO) regulator configured to generate an output voltage according to an input voltage, the LDO regulator including:
an amplifier configured to output a voltage according to variation in the output voltage; and
a first transistor that outputs the output voltage at a voltage level according to the first voltage; and
a booster circuit including:
a second transistor configured to output an output current that is proportional to an output current of the first transistor;
a first differential amplifier configured to output a first voltage signal according to a voltage difference between a first reference voltage and a voltage corresponding to the output current of the second transistor; and
a control circuit configured to control responsiveness of the amplifier according to the first voltage signal.

2. The power supply circuit according to claim 1, wherein the output current of the second transistor is smaller than an output current of the first transistor.

3. The power supply circuit according to claim 2, wherein
the first transistor and the second transistor comprise a current mirror circuit in which gates or bases of the first and second transistors are connected to each other, and
a value obtained by dividing a gate width of the first transistor by a gate length of the first transistor is greater than a value obtained by dividing a gate width of the second transistor by a gate length of the second transistor.

4. The power supply circuit according to claim 1, wherein the first transistor and the second transistor are field effect transistors.

5. The power supply circuit according to claim 1, wherein
the LDO regulator includes a first impedance circuit connected in series with an output current path of the first transistor,
the booster circuit includes a second impedance circuit that is connected in series with an output current path of the second transistor and outputs a current that is proportional to a current flowing through the first impedance circuit,
the output voltage is output from a connection node between the first transistor and the first impedance circuit, and
the voltage according to the output current of the second transistor is supplied at a connection node between the second transistor and the second impedance circuit.

6. The power supply circuit according to 1, wherein the control circuit operates to boost responsiveness of the amplifier as long as the first transistor outputs the output current.

7. The power supply circuit according to claim 1, wherein the amplifier includes:
a second differential amplifier configured to output a second voltage signal according to a voltage difference between a second reference voltage and the voltage corresponding to the output voltage;
a current source configured to generate a current which flows through the second differential amplifier; and
a control port which allows the current which flows through the second differential amplifier to be adjusted, and wherein
the control circuit adjusts the current that flows through the second differential amplifier via the control port in response to the first voltage signal.

8. The power supply circuit according to claim 1, further comprising:
an output port connected to the first transistor and configured to output the output voltage; and
a voltage hysteresis circuit configured to increase the voltage which is compared with the first reference voltage when a load current that flows from the first transistor into the output port increases.

9. The power supply circuit according to claim 1, further comprising:
an output port connected to the first transistor and configured to output the output voltage; and
a delay circuit configured to delay a stopping of an operation of the booster circuit improving responsiveness of the amplifier when a load current that flows from the first transistor into the output port becomes zero.

10. A power supply circuit, comprising:
a low drop out (LDO) regulator configured to output an output voltage according to an input voltage, the LDO regulator having an amplifier that outputs a voltage corresponding to the output voltage and a first transistor configured to output the output voltage at a voltage level corresponding to the voltage output from the amplifier; and
a booster circuit including:
a first differential amplifier configured to output a first voltage signal according to a voltage difference between a first reference voltage and a gate voltage or a base voltage of the first transistor; and
a control circuit configured to set responsiveness of the amplifier according to the first voltage signal.

11. The power supply circuit according to claim 10, wherein
the first differential amplifier includes a second transistor and a third transistor which are coupled to each other,
a gate or a base of the second transistor is connected to a gate or a base of the first transistor, and
the first reference voltage is supplied to a gate or a base of the third transistor.

12. The power supply circuit according to 10, wherein the control circuit operates to boost responsiveness of the amplifier as long as an output current of the first transistor is not zero.

13. The power supply circuit according to claim 10, wherein the amplifier includes:
a second differential amplifier configured to output a second voltage signal according to a voltage difference between a second reference voltage and the voltage corresponding to the output voltage;
a current source configured to generate a current which flows through the second differential amplifier; and
a control port which allows the current which flows through the second differential amplifier to be adjusted, and wherein
the control circuit adjusts the current that flows through the second differential amplifier via the control port in response to the first voltage signal.

14. The power supply circuit according to claim 10, further comprising:
an output port connected to the first transistor and configured to output the output voltage; and
a voltage hysteresis circuit configured to increase the voltage which is compared with the first reference voltage when a load current that flows from the first transistor into the output port increases.

15. The power supply circuit according to claim 10, further comprising:
an output port connected to the first transistor and configured to output the output voltage; and
a delay circuit configured to delay a stopping of an operation of the booster circuit improving responsiveness of the amplifier when a load current that flows from the first transistor into the output port becomes zero.

16. A power supply circuit, comprising:
a first amplifier outputting a control voltage according to a comparison of a first reference voltage to a feedback voltage corresponding to an output voltage;
a first transistor receiving a first input voltage and supplying the output voltage according to the control voltage;
a second transistor receiving a second input voltage and outputting a voltage according to the control voltage;
a first differential amplifier configured to output a first voltage signal according to a difference between a second reference voltage and the voltage output by the second transistor; and
a control circuit configured to adjust responsiveness of the first amplifier according to the first voltage signal.

17. The power supply circuit according to claim 16, wherein the first and second transistors are PMOS transistors.

18. The power supply circuit according to claim 16, wherein the first and second transistors are NMOS transistors.

19. The power supply circuit according to claim 16, further comprising:
a voltage hysteresis circuit connected to the second transistor.

20. The power supply circuit according to claim 16, further comprising:
a delay circuit configured to supply a delay signal to the amplifier delaying a reduction in responsiveness of the amplifier for a predetermined time.
